(19) United States
(12) Patent Application Publication
(10) Pub. No.: US 2017/0088802 A1
(43) Pub. Date: Mar. 30, 2017

(54) DEVICE AND METHOD FOR PRECIPITATING SOLIDS FROM A SUSPENSION INCLUDING DISSOLVED GASES

(71) Applicant: Friedrich Banke, (US)

(72) Inventors: Friedrich Banke, Markt Schwaben (DE); Markus Langer, Altenstadt (DE)

(73) Assignee: Friedrich Banke, Hohenpoling (DE)

(21) Appl. No.: 15/242,555

(22) Filed: Aug. 21, 2016

(30) Foreign Application Priority Data
Sep. 30, 2015 (DE) DE102015116626.7

(51) Int. Cl. C12H 1/07; B30B 9/12; B01D 29/11; B01D 29/64; B01D 29/76; B01D 29/94

(52) U.S. Cl. CPC C12H 1/063; B01D 29/76; B01D 29/94; B01D 29/117; B01D 29/6476; B30B 9/128

(57) ABSTRACT

A device for a precipitating solid material particles from a suspension of a brew liquid including dissolved CO₂ and plant based aroma hearer solid material particles, the device including a filter surface which separates a non-filtrate space from a filtrate space wherein the non-filtrate space receives the suspension; a suspension inlet leading into the non-filtrate space, a filtrate outlet opening into the filtrate space; a mechanical compressor that is provided in the non-filtrate space and configured to feed the suspension under a separation of the brew liquid through the filter surface within the non-filtrate space along the filter surface to a compression portion of the non-filtrate space and to compress the remaining solid materials: and a solid material output opening provided in a wall of the non-filtrate space in the compression portion of the non-filtrate space wherein the solid material output opening is closeable tight relative to an ambient atmosphere.

### RELATED APPLICATIONS

This application claims priority from and incorporates by reference German Patent Application DE 10 2015 116 626.7 filed on Sep. 30, 2015.

### FIELD OF THE INVENTION

The invention relates to a device for precipitating solid materials from a suspension including dissolved gasses. The invention relates in particular for a device for precipitating plant based aroma bearer solid material particles included in a brew liquid. The invention furthermore relates to a method for precipitating solid material particles from a suspension including dissolved gases using the device recited supra.

### BACKGROUND OF THE INVENTION

When brewing for example beer the finished beer is often mixed with plant based aroma bearers for example hops aroma pressed blanks, so called hops pellets in order to provide specific aromas to the beer. These hops pellets disintegrate in the beer and thus aromatic substances included in the plant based components are transferred to the beer. At the end of the aroma transfer process called hopping, the plant based solid material particles have to be separated again from the brew liquid, thus e.g. the beer.

In the art this solid material particle precipitation is performed by sedimentation wherein the solid material particles accumulate at a base of a precipitation container and the brew liquid is discharged at an upper end of the container. Sludge that collects at a base of the precipitation container is extracted from the container at an end of the precipitation process. This sludge, however, still contains substantial amounts of the brew liquid which is then lost in the process. Thus, beer loses of up to 50% have already been measured in sedimentation methods of this type. In beer types, like for example Pale Ale or Indian Pale Ale with a dosing of pallets in a range of 200 g/hl to 600 g/hl (grams of hops pallets per 100 liters of beer) loses of 15% to 40% are typical.

Alternatively there is an option to centrifuge the suspension including the brew liquid and the hops solid material particles, however significant amounts of liquid are required to extract the precipitated solid materials so that the beer loses compared to sedimentation can only approximately be cut in half and this method furthermore requires large investments.

Under high solid loading for example also decanters are used for separating the solids wherein the decanters cause a substantially lower loss of liquid but they also require very substantial capital investment.

From DE 13 2012 110 830 A1 a device is known which precipitates solid material particles from a suspension at a sifting device.

Furthermore also so called continuous filters that are known from water processing can be used for precipitating solid materials. However, these filters also discharge the solid materials through flushing so that also this method causes substantial beer loses.

Preventing beer and aroma losses is also a goal of a device by the inventor according to the known pre published application DE 10 2015 112 270.7 where the hops solid materials are flushed in the form of a compact filter cake against a filter surface and thus extracted. Using this method the beer and wort loss can be reduced to a minimum by a process step of cake washing after extracting the aromatic substances. For large amounts of hops, however the described filter device represents a large investment. Furthermore there is a risk that the filter cake including the hops particles clogs when a lot of yeast is in the beer or in the young beer so that an economical operation of the arrangement is not feasible anymore.

In order to separate solids from agricultural liquid wastes, like for example manure so called press screw separators are Known, for example from EP 0367 037 B1 which provide continuous solid material precipitation wherein the solid materials are expelled as a dry filter cake. These separators, however are not suitable for an application for precipitating hops solid materials from beer since brew liquid including CO₂ like e.g. beer would foam up therein.

### BRIEF SUMMARY OF THE INVENTION

Thus, it is an object of the instant invention to provide a device and a method for precipitating solid material particles from a suspension including dissolved gases, in particular a suspension made from a brew liquid including dissolved CO₂ and plant based aroma bearer solid material particles which have a high level of effectiveness which facilitate minimizing a loss of brew liquid.

The object is achieved by a device for precipitating solid particles from a suspension including dissolved gases in particular a suspension including dissolved CO₂, in particular a suspension made from a brew liquid including dissolved CO₂ and plant based aroma bearer solid material particles, the device including a filter surface which separates a non-filtrate space from a filtrate space wherein the non-filtrate space receives the suspension; a suspension inlet leading into the non-filtrate space; a filtrate outlet opening into the filtrate space; a mechanical compressor device that is provided in the non-filtrate space and configured to feed the suspension under a separation of the brew liquid through the filter surface within the non-filtrate space along the filter surface to a compression portion of the non-filtrate space and to compress the remaining solid materials; and a solid material output opening provided in a wall of the non-filtrate space in the compression portion of the non-filtrate space wherein the solid material output opening is closeable gas tight and pressure tight relative to the ambient atmosphere.

The device according to the invention is provided with a filter surface which separates a non filtrate space including the suspension from a filtrate space including a suspension inlet opening into the non-filtrate space and a filtrate outlet opening into the filtrate space with a mechanical compressing device that is provided in the non-filtrate space and configured to feed the suspension within the non-filtrate space along the filter surface to a compression portion of the non-filtrate space while precipitating the brew liquid through the filter surface and to compress the remaining solids and including a solid material outlet opening in a wall of the non-filtrate space in a compression portion wherein the solid material outlet opening is configured sealable gas tight and pressure tight relative to an ambient atmosphere.

This device advantageously facilitates continuous precipitation operations which provides a high level of brew liquid recovery through the compression of the solid materials into a solid material cake which is continuously extracted through the solid material outlet opening. Sealing the non-filtrate space gas tight and pressure tight facilitates maintaining the non-filtrate space pressure sealed relative to the ambient atmosphere when starting the precipitation process when no filter cake has formed yet. When a solid material cake has been built up which is extracted through the open solid material output opening the solid material cake performs this sealing function and the non-filtrate space remains closed gas tight relative to ambient. Since the suspension inlet and the filtrate outlet being components of the brew liquid conduits of the brewery plant are also closed gas tight relative to ambient no CO₂ or almost no CO₂ exits from the brew liquid when operating the device according to the invention which prevents the brew liquid from foaming. Sealing the solid material outlet opening and thus the non-filtrate space gas and pressure tight while starting up the precipitation process thus maintains an opposite pressure which prevents a separation of CO₂ from the brew liquid, for example from the beer during start-up operations. After the filter cake has been. built up the filter cake seals the non-filtrate space and thus maintains the counter pressure.

Experiments by the inventor have shown that approximately two kilograms to three kilograms of liquid are in in the solid material cake per kilogram of hops solid material when pressing hops solid material suspension. Thus, typical hops dosages of 400 g/hl to 600 g/hl for strongly hopped beers yield losses in a range of 1% to 2% compared to 20% to over 30% of losses for prior art sedimentation and sludge remove from the storage tank.

Experiments by the inventor have shown that a filter with a particle permeability of up to 50 μm already retains over 95% of the hops particles.

Further advantageous embodiments of the device according to the invention are included in the dependent claims 2-12.

Advantageously the mechanical compressing device is formed by a screw compressor which is rotate ably arranged in a sieve tube including the filter surface. This embodiment provides continuous separation in a particularly effective manner.

Thus it is advantageous when the compressor screw includes a feed section and a compressor section. The feed section provides a continuous transport of the suspension to the compressor section along the filter surface so that a materials separation is already provided at this location, wherein the thickened suspension that precipitates on the filter surface is transported from the feed section of the compressor screw to the compressor section. This prevents a clogging of the filter in this filter section associated with the compressor section of the compressor screw. Thus it is particularly advantageous when the feed section continuously transitions into the compressor section which provides a continuous thickening of the suspension along the filter surface until a compressed filter cake is formed.

It is thus particularly advantageous when a helical radially outer edge of the compressor screw is arranged directly adjacent to the filter surface. This provides a particularly effective transportation of the thickened suspension along the filter surface.

Advantageously the compressor screw at least at its helical radially extending edge is provided with at least one scraping device which contacts and cleans the filter surface when the compressor screw rotates.

In an alternative embodiment the compressor device includes a piston which is axially moveable in a cylinder including the filter surface and radially defining the non-filtrate space between a decompression position and a compression position, wherein bypass devices are provided which facilitate a flow of suspension into the compression portion of the non-filtrate space when the cylinder is moved into the decompression position. This compressor device configured as piston compressor facilitates oscillating permanent operations which are quasi continuous.

Thus, the bypass devices are formed by openings in the piston which are advantageously provided with check valves so that pulling back the piston from the compression position facilitates an ensuing flow of suspension into the compression cavity.

in an advantageous embodiment of the device according to the invention the solid material outlet opening is provided with a closure element which is preloaded by a preload force in a closed position in which the solid material outlet opening is closed by the closure element gas tight and pressure tight. This closure of the solid material outlet opening is provided at a point in time when no compacted solid material cake has formed yet, thus in the start-up condition of the arrangement. When a solid material cake has already formed the propulsion force imparted by the compressor device upon the solid material cake counteracts the preload force of the closure element. The solid material cake thus displaces the closure element and is pushed out by the compressor device through the solid material outlet opening that opens in this manner Since the compacted solid material cake that exits through the solid material outlet opening closes the solid material outlet opening gas tight maintaining a positive pressure in the non-filtrate space and in the filtrate space is also provided in this condition.

It is advantageous when the closure element is preloaded by a spring into the closed position against a sealing seat of the solid material outlet position. This facilitates an automatic resealing of the solid material outlet opening should the solid material flow be interrupted.

Another advantageous embodiment to the invention includes a pneumatic cylinder impacting the closure element in order to preload the closure element wherein the pressing force is adaptable in a simple and flexible manner by changing the a pressure.

In another embodiment the solid material outlet opening is connected with a solid material outlet conduit which opens into a pressurized solid material collecting container. This embodiment does not require a preloaded closure element for the solid material outlet opening. The gas pressure in the pressurized solid material collecting container causes the required counter pressure in the solid material outlet opening so that no gas is released from the brew liquid. The solid material collecting container is provided with a closeable outlet opening through which the accumulating solid materials can be released in batches for example when the continuous dissipation operations in the dissipation device have been terminated.

In this embodiment it is advantageous when the solid material collecting container includes a pressurized gas connection through which pressurized gas is introducible into an interior of solid material collecting container. Through this pressurized gas connection pressurized gas can be introduced into the solid material collecting container and released therefrom so that the counter pressure can be kept constant for an increasing solid material level in the solid material collecting container.

Another advantage of this variant is the option to further recover brew liquid remaining in the solid material through washing the solids materials precipitated in the solid material collecting container through re-suspension. Thus, for example degassed water is added into the solid material collecting container so that a suspension is generated again and the suspension is put back into the device according to the invention so that the remaining brew liquid can be recovered to a large extent under a renewed precipitation.

An embodiment of the device according to the invention is particularly advantageous in which at least one fluid inlet opening for a washing liquid for washing the solid material filter cake is provided in the compression portion of the non-filtrate space. Through this fluid inlet opening the already compressed but not yet completely compressed solid material cake can be diluted with a washing liquid, for example water. This washing liquid penetrates the capillaries forming in the solid material cake during a further compression of the solid material cake and displaces brew liquid stored in the capillaries so that this brew liquid can also be reclaimed. he washing liquid penetrating into the capillaries remains in the capillaries and cannot be driven from the capillaries also during a further compression of the solid material cake so that the brew liquid is not diluted by adding the washing liquid.

The cake washing causes a further reduction of the extraction losses from the brew liquid. A dilution through the washing water can be compensated by stronger extract concentration during initial brewing, so that the desired extract concentration (original wort) is also provided again together with the washing water at the end of the process.

The object is also achieved by a method with, the features of claim 13.

This method according to the invention for precipitating solid materials from a suspension including dissolved gases, in particular a suspension including dissolved CO₂ and plant based aroma bearer solid material particles with a device according to one of the preceding claims includes the following steps:
a) continuously feeding the suspension from a brew liquid including solid material particles into the non-filtrate space;
b) feeding the suspension in the non-filtrate space along the filter surface while precipitating the brew liquid through the filter surface and compressing the solid materials to form a compressed solid material filter cake;
c) continuously extracting the filter cake from the non-filtrate space through the solid material outlet opening while maintaining a positive pressure in the non-filtrate space relative to an ambient atmosphere

This method achieves the advantages that were already described with reference o the device according to the invention.

Advantageously the solid material outlet opening during start-up of the device until a compressed solid material cake is built up is:
either closed by a closure element, or
fluid connected with an external pressure cavity where a pressure is provided which corresponds to the positive pressure in the non-filtrate space

In order to also reclaim the brew liquid that is held in the capillaries of the solid material cake a washing liquid, for example water is added to the solid material cake shortly before it reaches its maximum compression wherein the washing liquid displaces the brew liquid from the capillaries and remains there during a further compression of the solid material cake and does not exit therefrom.

### BRIEF DESCRIPTION OF THE DRAWINGS

Advantageous embodiment of the invention with additional configurative details and additional advantages are subsequently described with reference to the appended drawing figures wherein:

FIG. 1 illustrates a schematic sectional view of a first embodiment of the device according to the invention;

FIG. 1A illustrates an enlarged view of detail A of FIG. 1;

FIG. 1B illustrates detail B of FIG. 1 for a closed solid material outlet opening;

FIG. 2 illustrates a schematic sectional view of a derivative of the first embodiment according to FIG. 1;

FIG. 3 illustrates a schematic sectional view of a second embodiment of the device according to the invention;

FIG. 4 illustrates a schematic sectional view of a third embodiment of the device according to the invention;

FIG. 4A illustrates and enlarged view of detail A of FIG. 4, and

FIG. 5 illustrates a schematic process diagram of a detail of a brewing arrangement with a device according to the invention.

### DETAILED DESCRIPTION OF THE INVENTION

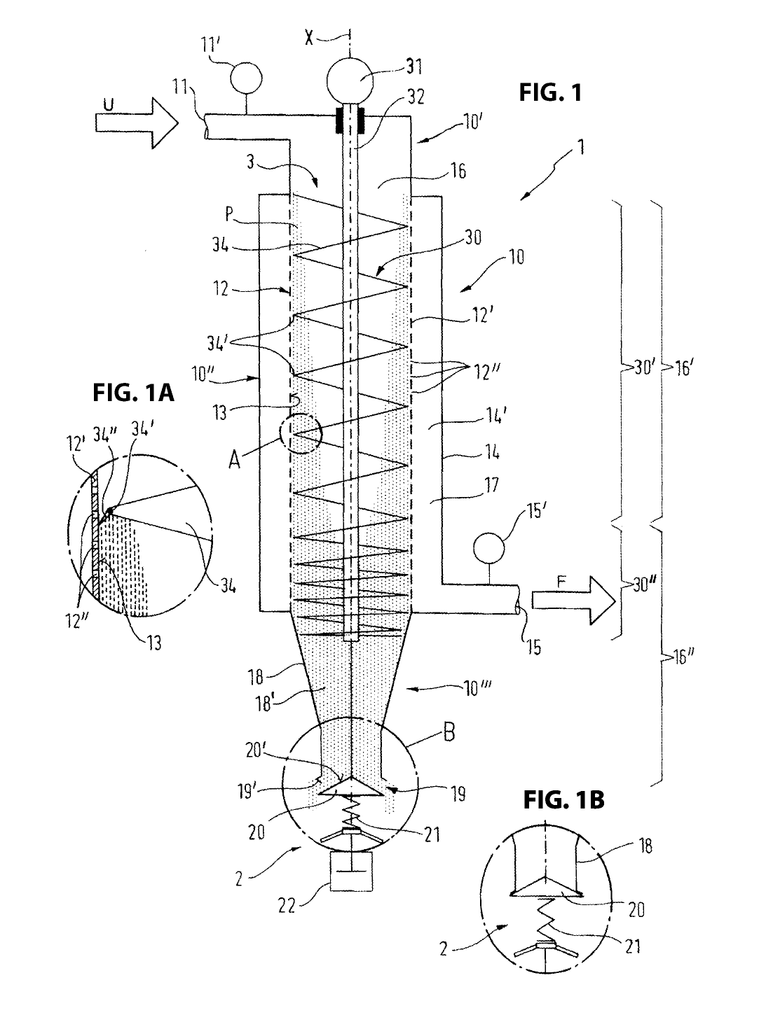

FIG. 1 illustrates a schematic sectional view of device 1 for precipitating solid material particles according to a first embodiment of the instant invention

The device 1 includes a housing 10 with an inlet portion 10′, a cylindrical center portion 10″ and an outlet portion 10′″. The inlet portion 10′ is provided with a suspension inlet 11 through which a suspension including brew liquid and solid material particles forming a non-filtrate, for example made from young beer and plant based aroma bearer solid materials like e.g. hops pellets is introducible.

In the cylindrical center portion 10″ of the housing 10 a cylindrical sieve element 12 is internally arranged, wherein a cylindrical circumferential wall 12′ of the sieve element is provided with sieve openings 12′ so that a filter surface 13 is formed. The sieve element 12 can be provided as gap sieve, hole sieve or it can be provided from fabric material wherein a gap width or a hole diameter is between 5 μm and 100 μm, advantageously between 20 μm and 50 μm.

An outer wall 14 of the center portion 10″ of the housing 10 is arranged about the circumferential wall 12′ of the sieve element 12 that is provided with the sieve openings 12″ wherein the outer wall 14 is arranged at a radial distance from the circumferential wall 12′. Thus, an annular cavity 14 is formed between the circumferential wail 12′ of the sieve element 12 that is provided with the sieve openings 12″ and the outer wall 14 of the center portion 10′.

The interior of the cylindrical sieve element 12 forms an non-filtrate cavity 16 together with the inlet portion 10′ and the annular space 14′ enveloping the sieve element 12 forms a filtrate space between the sieve surface 13 and the cylindrical wail 14 of the center portion 10″ of the housing 10.

The cylindrical center portion 10″ of the housing 10 is provided with a filtrate outlet 15 at its end oriented away from the inlet portion 10′, wherein the filtrate outlet opens into the annular cavity 14′ and facilitates draining liquid that has passed through the filter surface 13.

The outlet portion 10′″ is provided on a side of the housing 10 that is oriented away from the inlet portion 10′ wherein the outlet portion is fluid connected with an interior of the cylindrical sieve element 12, thus with the non-filtrate space 16 and wherein the outlet portion is configured adjacent to the cylindrical sieve wall 13 as a closed wall 18 which tapers cone shaped. At a free end of the outlet portion 10′″ a solid material outlet opening 19 is provided which is provided with a sealing surface 19′.

A closure device 2 is provided in front of the solid material outlet opening 19 wherein the closure device includes a closure element 20 which is movable or also preloadable with a cone shaped sealing surface 20′ against the sealing seat 19′ of the solid material outlet opening 19 using an actuator 22. The closure element 20 is thus preloaded by a compression spring 21 in a direction towards the sealing seat 19′ of the solid material outlet opening 19 so that the solid material outlet opening 19 is closed gas tight and pressure tight by the closure element 20 in an idle position of the closure device 2 (FIG. 1B). The compression spring 21 can also be omitted and the preload of the closure element 20 can be provided solely by the actuator 22. The preload of the closure element 20 can also be provided weight loaded by a non illustrated lever arrangement that is loaded with at least one weight element,

A compressor device 3 is arranged in the interior of the cylindrical sieve element 12 coaxial with the cylinder axis X. The compressor device 3 is provided as a compressor screw 30 and includes a screw shaft 32 that is drivable by a motor 31 wherein a screw helix 34 that is only stylized in the figures is arranged at an outer circumference of the screw shaft along an axial extension of the screw shaft and provided as a feed device. The radial outer edge 34 of the screw helix 34 is directly adjacent to the filter surface 13 and is provided with at least one scraping device 34″ which contacts the filter surface 13 as illustrated in FIG. 1A.

The screw helix 34 forms a feed section of the compressor screw 30 with its upper portion oriented towards its inlet portion 10, wherein the feed section extends over a largest portion of an axial extension of the filter surface 13, thus approximately 75%-80% of the axial extension of the filter surface 18, and which then transitions into a compressor section 30″. A pitch of the screw helix 34 is flatter in the compressor section 30″ than in the feed section 30′ so that an axial feed per revolution of the compression screw in the feed section 30′ is greater than in the compressor section 30″. The compressor screw 30 extends with its compressor section 30′ beyond an end of the filter surface 13 oriented towards the outlet portion 10′ into the cone shaped compression space 18′ of the outlet portion 10′″. Thus, a radius of the screw helix 34 in the portion of the compressor section 30′ is slightly reduced in order to be able to engage in the conically tapering outlet portion 10′″.

In a starting condition, thus when no suspension has been filled into the device the closure device 2 is closed as illustrated in FIG. 1B. Thus, the spring 21 presses the closure element 20 with its valve seat 20′ against the valve seat 19′ of the solid material outlet opening 19 of the outlet portion 10′″ which closes the solid material outlet opening gas tight and pressure tight. The closing force of the closure device 2 that is applied by the spring 21 configured as a compression spring is thus selected large enough, so that a predetermined system pressure that is provided in an interior of the device is smaller than a closing pressure that is imparted by the spring 21 of the closure device 2 upon the sealing seat 19′ of the solid material outlet opening 19.

In this condition with a closed solid material output opening 19 the suspension U including a brew liquid including dissolved carbon monoxide and plant based aroma bearer solid material particles, wherein the suspension is also referred to as non filtrate, is continuously introduced through the suspension inlet 11 into the non-filtrate space 16 under a positive pressure relative to ambient atmosphere. This positive pressure can be measured in the suspension inlet 11 with a manometer 11′. The suspension flows through the inlet portion 10′ into the cylindrical center portion 10″ to the circumferential wall 12′ of the sieve element 12 that is provided with the sieve openings 12″. At this location the brew liquid included in the suspension passes through the sieve opening 12″ into the annular space 14′ while the solid material particles P accumulate on the filter surface 13 at a radially inner side of the circumferential wall 12′ of the sieve element 12. The brew liquid designated herein as filtrate F which has flowed through the filter surface 13 into an annular cavity 14′ forming a filtrate space 17, is drained through the filtrate outlet 15 from the device 1 according to the invention towards a subsequent process step. A positive pressure relative to the ambient atmosphere is also provided in the filtrate outlet 15 wherein the positive pressure can be measured by a manometer 15′.

The solid material particles P precipitating on the filter surface 13 are fed by the rotating compressor screw 30 to the outlet portion 10″ of the housing 10. Thus, the scraping devices 34′ clean the filter surface 13 and the screw helix 34 moves the solid material particles P with the feed section 30′ of the compressor screw 30 along a feed portion 16′ of the non-filtrate space 16 to a compression portion 16″ of the non-filtrate space 16 proximal to the conically shaped outlet portion 10′″ where the compressor screw 30 includes the compressor section 30″.

The lower pitch of the screw helix 34 in the portion of the compressor section 30″ an axial feed of the fed solid material particles P is less than in the feed section 30′ so that the solid material particles P in the compressor section 30″ are pressed into a solid material cake, wherein the remaining brew liquid is pressed out of the solid material cake and flows through the filter surface 13 in outward direction into the filtrate space 17. The solid material particles P that are compressed into a solid material cake are compressed even further by a conically tapering profile of the outlet portion 10′″. This compressed solid material cake is pressed against the closure element 20 of the closure device 2 by a force of the rotating compressor screw 30 and displaces the closure element 20 against the force of the compression spring 21. The solid materials output opening 19 is thus opened and the solid material cake can exit from the device in an outward direction The strong compression of the solid material cake in the outlet portion 10′″ compresses the solid material cake into a solid gas tight mass which contacts an inner wall of the outlet portion 10′″ closely so that no positive pressure can exit from the device 1, in particular not from the non-filtrate space 15 through the open solid material output opening 19. Maintaining the positive pressure in the device 1 is thus also provided for an open closure device 2.

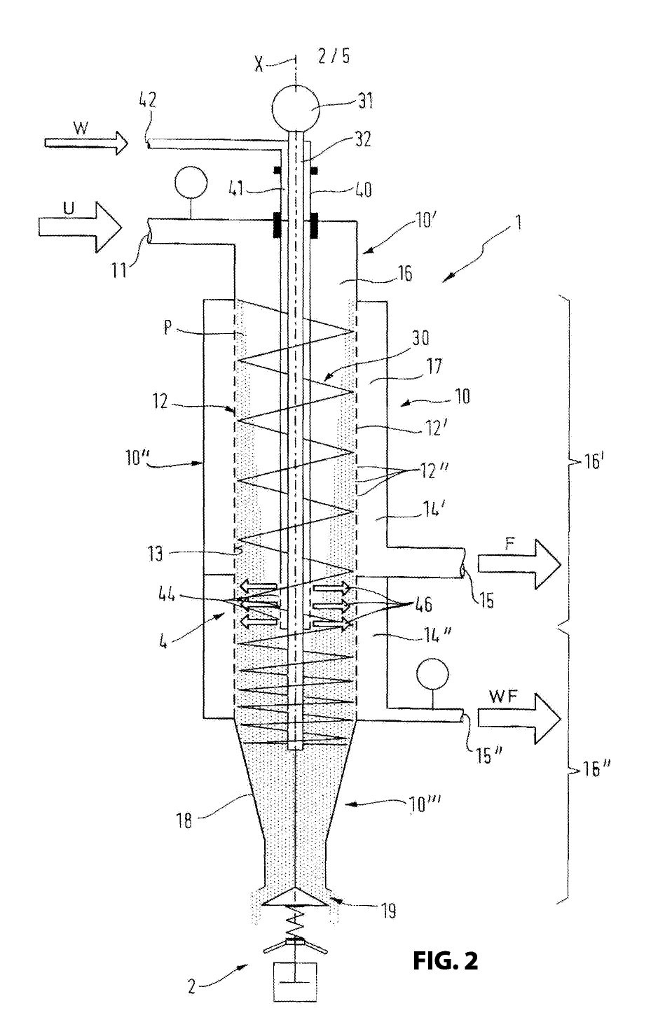

A variation of the device illustrated in FIG. 1 is illustrated in FIG. 2. identical reference numerals as in FIG. 1 designate like or identical components in FIG. 2. Therefore subsequently only deviations from the embodiment of FIG. 1 are described.

The cylindrical center portion 10″ of the device 1 is provided with a second lower annular space 14″ that is arranged below the annular space 14′ forming the filtrate space 17 and sealed relative to the annular space 14′. The circumferential wail 12′ of the sieve element 12 that is provided with the sieve openings 12″ thus extends in the axial direction over a length of the first annular space 14′ and the second annular space 14″ arranged thereunder. The compressor section 30″ of the compressor screw 30 is enveloped by the second annular space 14″. The first annular space 14′ is provided with the filtrate outlet 15 already described in conjunction with FIG. 1 which, however, is now arranged above the second annular space 14″. The second annular space 14″ includes an outlet 15″ at an end arranged adjacent to the outlet portion 10′″.

The screw shaft 32 in the variant of FIG. 2 includes a washing liquid tube 40 enveloping the shaft core wherein the washing liquid tube is part of a solid material cake washing device 4. The washing liquid tube 40 forms a washing liquid annular space 41 about the core of the screw shaft 32 and is provided with a washing liquid inlet 42 at an end protruding from the inlet portion 10′. The portion of the washing liquid tube 40 arranged in an interior or the housing 10 co-rotates with the compressor screw 30. Washing liquid W can be introduced through the washing liquid inlet 42 into the washing liquid annular space 41. The washing liquid tube 40 enveloping the screw shaft 32 extends into a portion of the compressor screw 30 which is enveloped by the second annular space 14″ thus to the compressor section 30″.

There the washing liquid tube 40 is provided with radially arranged outlet openings 44 through which washing liquid can enter into the non-filtrate space 16 and thus into the solid material cake forming at this location shortly before its maximum compression as indicated by the arrows 46.

The washing entering the solid material cake that is also designated as filter cake displaces the brew liquid stored in the capillaries when the solid material cake is compressed and releases the brew liquid so that the brew liquid together with the optionally overdosed washing liquid can flow in the compression portion 16″ through the portion of the sieve element 12 formed at this location into the second annular space 14″. This mixture WF made from washing liquid and brew liquid is drained through the outlet 15 to a subsequent process step where the brew liquid can be separated from the washing liquid mixed therewith.

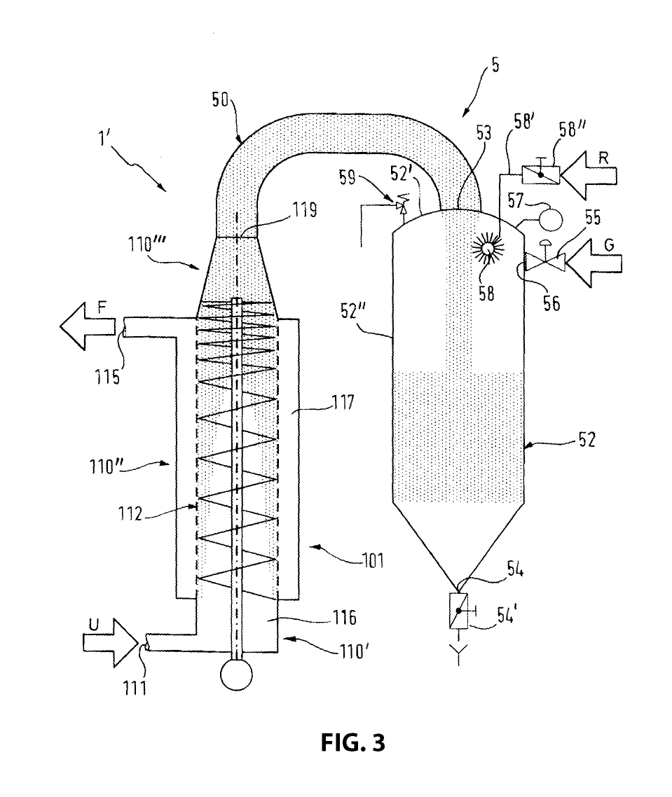

FIG. 3 illustrates a schematic sectional view of a second embodiment of the device 1 according to the invention which is also configured with a compressor screw 30 provided as a compression device. Also in FIG. 3 the identical reference numerals as in FIG. 1 designate like or identical components which have already also been described with reference to FIG. 1 so that only deviations from FIG. 1 are subsequently described.

Whereas in the embodiment of FIGS. 1 and 2 the suspension inlet 11 is arranged above the sieve element 12 provided in the cylindrical center portion 10″ and the filtrate outlet 15 and the solid material output opening 19 are arranged below the suspension inlet 11 so that the suspension in an interior of the device 1 flows downward gravity induced the flow direction in an interior of the device 1′ is oriented opposite to the flow direction according to FIG. 3. The suspension inlet 111 and the inlet portion 110′ of the housing 110 are arranged in the illustrated embodiment below the cylindrical center portion 110″ of the housing 110 in which the sieve element 112 is arranged like in the embodiment of FIG. 1. The filtrate outlet 115 is provided at a level of the upper end of the sieve element 12.

The solid material outlet opening 119 of the outlet portion 110′″ in the embodiment according to FIG. 3 differently from the embodiment according to FIG. 1 leads into one end of a solid material output conduit 50 of a solid material collecting device 5. The solid material output conduit 50 opens with its other end into a solid material collecting container 52 in whose upper portion in the illustrated embodiment into a solid material feed opening 53 in a cover 52′ of the solid material collecting container 52. The solid material collecting container 52 is provided at its lower end with a blockable outlet opening 54 for the accumulated solid material particles. In the upper portion of the solid material collecting container 52 a compressed gas inlet 56 is provided which is blockable by a valve 55 wherein a compressed gas G, for example carbon dioxide is introducible into the solid material collecting container 52. The pressure in an interior of the solid material collecting container 52 can be measured with a manometer 57. A pressure maintaining valve 59 is provided in the wail 52″ of the solid material collecting container 52 wherein an increasing positive pressure that is built up while the solid material collecting container 52 is being filled can be released so that an inner pressure in the solid material collecting container 52 does not increase beyond a predetermined level when the solid material collecting container is filled with solid material particles.

Furthermore a cleaning device 58 is provided in an upper portion of the solid material collecting container 52 wherein a cleaning fluid R is provided to the cleaning device through a cleaning fluid conduit 58 which is block able by a cut off valve 58″ wherein the cleaning fluid can be introduced into the solid material collecting container 52. The volume of the solid material collecting container 52 is sized so that the solid material collecting container 52 can receive all solid materials which are precipitated in a pre-determined time period during continuous operation of the device 101 for precipitating solid material particles.

Before the device 101 according to the invention is started up compressed gas G is introduced through the compressed gas inlet 56 into the solid material collecting container 52 and thus also into an interior or the device 101, in particular into its non-filtrate space 116 and its filtrate space 117. The device 101 is thus preloaded relative to the atmosphere with a predetermined positive pressure which prevents that CO₂ that is dissolved in the brew liquid suspension subsequently introduced through the suspension inlet 111 gases out.

After the continuous operation of the device 101 has been completed the outlet valve 54′ of the solid material outlet opening 54 of the solid material collecting container 52 is opened and the cleaning fluid R is introduced through the cleaning fluid inlet 58 into the solid material collecting container 52. Thus, the solid material stored in the solid material collecting container 52 is washed out and the solid material collecting container 52 is emptied and cleaned.

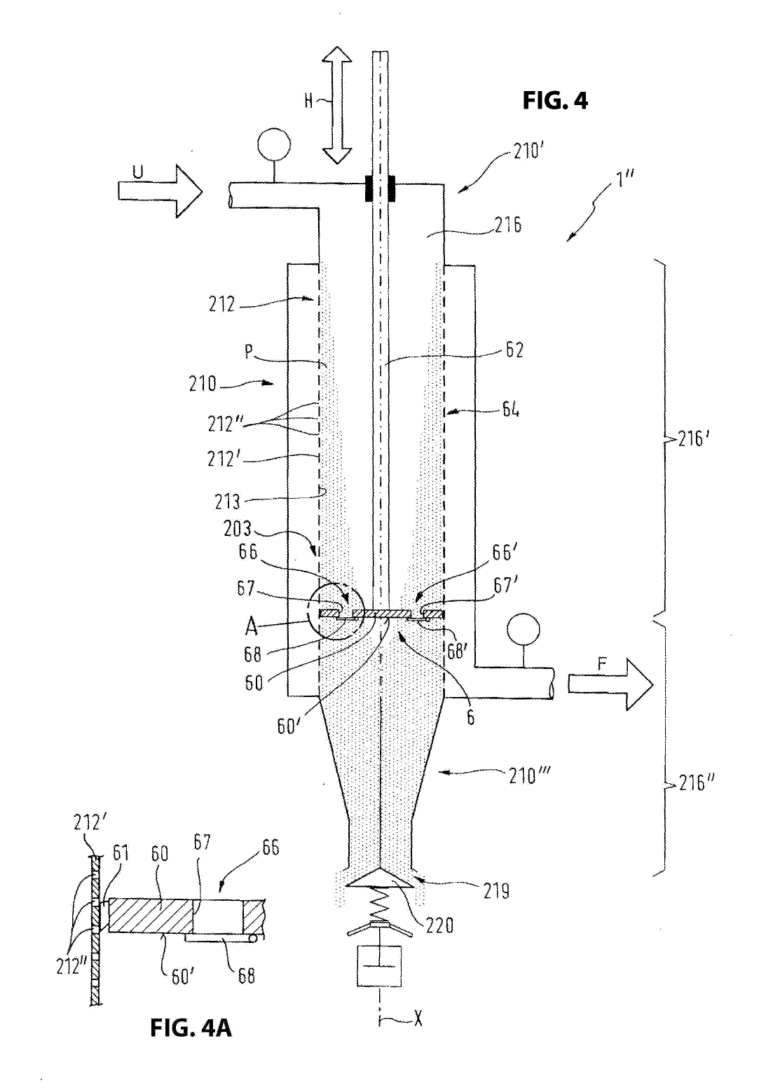

FIG. 4 illustrates a third embodiment of the device according to the invention. Also here identical reference numerals as in FIG. 1 designate like or identical components. Only deviations from FIG. 1 are subsequently described in detail

The device 1 illustrated in FIG. 4 includes a housing 210 which essentially corresponds the housing 10 of the embodiment according to FIG. 1. instead of the compressor screw 30 provided in the embodiment of FIG. 1, however a piston arrangement 6 is provided in an interior of the cylindrical sieve element 211 wherein the piston arrangement is moveable along the axis X of the sieve element 212, wherein the piston arrangement forms a piston cylinder unit together with the cylindrical sieve element wherein the piston cylinder unit forms a compressor device 203.

The piston arrangement 6 includes a piston 60 which is connected with a co-axial and axially moveable piston rod 62 that is arranged in the sieve element 212. The piston rod 62 is supported axially moveable in an inlet portion 210 of the housing 210 and run out of the inlet portion 210′ gas tight and pressure tight. A non illustrated drive of the piston rod is configured so that it can move the piston rod 62 with the piston 60 arranged thereon back and forth according to the double arrow H illustrated in FIG. 4. The piston stroke thus essentially corresponds to the axial extension of the filter surface 213, thus the portion of the circumferential wall 212′ of the sieve element 212 which is provided with the sieve openings 212″. Though a cross section of the sieve element 212 in the embodiment of FIG. 4, like in the embodiment of FIG. 1 is circular and thus also the piston 60 has a circular shape the invention also includes embodiments where a cross section of the piston 60 and the sieve element 212 is provided that is non-circular, for example oval or rectangular.

The piston is advantageously provided at its outer circumference with a piston ring shaped scraping device 61 (FIG. 4A) which contacts the filter surface 213 and which scrapes solid material particles off that adhere at the filter surface 213 during a downward movement of the piston 60, thus a movement oriented away from the inlet portion 210′ of the housing 210 and directed towards the outlet portion 210′″ and takes the solid material particles along towards the compression portion 216″ of the non-filtrate space 216.

In order for suspension U to be able to flow into a space in front of the piston (in FIG. 4, below the piston) during a reverse movement of the piston 60 thus from the compression portion 216″ back into the feed portion 216′ (in FIG. 4 in upward direction towards the inlet portion 210′) bypass devices 66, 66′ are provided in the piston 60 wherein the bypass devices respectively include an opening 67, 67′ penetrating the piston parallel to a piston axis wherein the opening is closeable respectively by a valve flap 68, 68′ that is provided on a face 60′ of the piston 60, that is oriented towards the compression portion 216″ wherein the valve flap is pivotably supported at the piston 60 when the piston 60 is moved into its compression position (in FIG. 4 in downward direction).

Solid material output is provided like in the embodiment of FIG. 1 through solid material output opening 219 that is closeable by a closure element 220. The invention however is not limited to this variant. The variant illus rated in FIG. 4 with a piston cylinder unit configured as a compressor device can also be combined with the solid material output device illustrated in FIG. 3 and described with reference thereto and arranged in a solid material collecting container. The piston arrangement 6 illustrated in FIG. 4 can also be provided in the portion of the piston with washing fluid outlet nozzles oriented towards the compression space 216″ in order to achieve the advantages described in conjunction with FIG. 2 with respect to filter washing shortly before the complete compression of the solid material cake and thus reclaiming of brew liquid held in the capillaries of the solid material cake also in this embodiment.

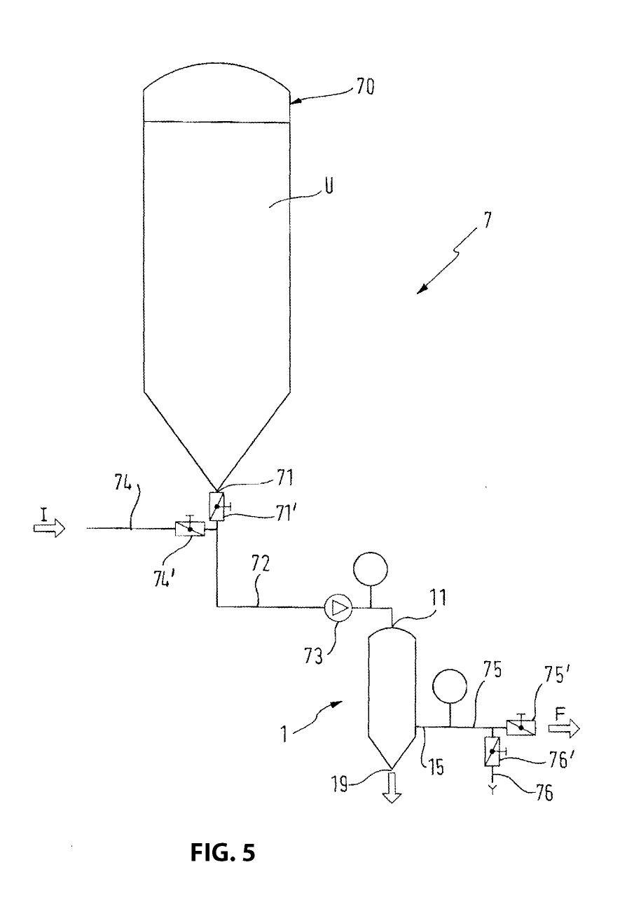

FIG. 5 illustrates an overview of a detail of a brewing arrangement 7 with a storage tank 70 in which a suspension U made from a brew liquid and plant based aroma bearer solid material particles, e.g. a suspension including young beer and dissolved hops pellets is stored. When a sufficient amount of aromatic substances has transitioned from the plant based aroma bearers into the brew liquid solid materials suspended in the brew liquid have to be precipitated again from the brew liquid. Thus, a cut off valve 71′ is provided at an outlet 71 of the storage tank 70 wherein the cut off valve establishes a fluid connection between an interior of the storage tank 70 and a feed conduit 72. In the feed conduit 72 which leads to the suspension inlet 11 of the device 1 according to the invention a feed pump 73 is provided. instead of the device 1 according to the invention illustrated in FIG. 1 certainly also the other embodiments of the device according to the invention as illustrated in FIGS. 2, 3 and 4 can be provided.

An inert gas conduit 74 is connected to the feed conduit 72 by a cut off valve 74′. The filtrate outlet 15 of the device 1 according to the invention is connected with an outlet conduit 75 which leads to a downstream non-illustrated storage tank for the filtered brew liquid F and which is blockable by a cut off valve 75′ Furthermore a cleaning outlet 76 that is lockable by a cut off valve 76′ is connected to the outlet conduit 75.

Now before the non-filtrate U is provided to the device 1 according to the invention the valves 71′, 75′ and 76′ are closed. Also the solid material outlet opening 19 of the device according to the invention as described in conjunction with FIG. 1 is closed gas tight and pressure tight by the closure element 20. The system closed in this way gas tight and pressure tight and including the device 1 with the connected conduits 72 and 75 is now initially flowed with inert gas I, for example CO₂ through the inert gas conduit 74 by opening the inert gas conduit 74′ wherein the cut off valve 76 is opened on the opposite side, for example in the cleaning outlet 76 so that air included in the system can escape. When air in an interior of the system has been replaced with the inert gas the valve 76′ is closed and a positive pressure of a predetermined magnitude is built up in the system by the inert gas.

In analogy to filling and flushing the device 1 with inert gas the filling and flushing can be performed in the same manner by degassed water. The inflow of degassed water is then arranged behind the cut off valve 71′ like the inert gas conduit 74 and the inert gas valve 74′.

The positive pressure from the preloading with the inert gas I has the effect that the suspension U can exit into an environment, namely into the feed conduit 72 which has the same positive pressure after opening the cut off valve 71′ at the outlet 71 of the storage container 70 which is also under the same positive pressure, so that a release of carbon dioxide from the brew liquid in the suspension does not occur and a foaming of the suspension is prevented. The suspension is then fed by the feed pump 73 through the feed conduit 72 to the suspension inlet 11 of the device 1 according to the invention and is processed there as is described supra so that the solid material particles are precipitated from the suspension and the essentially particle free brew liquid can be reclaimed wherein the brew liquid then flows through the filtrate outlet 15 and the outlet conduit 75 to the downstream storage tank.

The invention is not limited to the embodiment recited supra which only describes the core idea of the invention in broad strokes. Within the spirit and scope of the invention the device according to the invention can also have embodiments that differ from the embodiments described supra. Thus, the device can in particular have features which are a combination from the respective individual features of the claims.

Reference numerals in the claims, the description and in the drawing figures help to better understand the invention and do not limit the spirit and scope of the invention.

### REFERENCE NUMERALS AND DESIGNATIONS

1 device

1″ device

2 closure device

3 compressor device

4 solid material washing arrangement

5 solid material collecting device

6 piston arrangement

7 brewing plant

10 housing

10′ inlet portion

10″ cylindrical center portion

10′″ outlet portion

11 suspension net

11′ manometer

12 sieve element

12′ circumferential wall

12′ sieve openings

13 filter surface

14 outer wail

14′ first annular cavity

14″ second annular cavity

15 filtrate outlet/washing liquid outlet

15′ manometer

15″ outlet

16 non-filtrate space

16′ feed portion

16″ compression portion

17 filtrate space

18 closed wall

18′ compressor space

19 solid material output opening

19′ sealing surface/sealing seat

20 closure element

20′ cone shaped sealing surface

21 compression spring

22 actuator

30 compressor screw

30′ feed section

30″ compressor section

31 motor

32 screw shaft

34 screw helix

34′ radially outer edge

34″ scraping device

40 washing liquid tube

41 washing liquid annular space

42 washing liquid inlet

44 outlet openings

46 arrow

50 solid material output conduit

52 solid material collecting container

52′ cover of solid material collecting container

53 solid material feed opening

54 closeable output opening/solid material output opening

54′ output valve

55 valve

56 compressed gas inlet

57 manometer

58 cleaning device/cleaning fluid inlet

58′ cleaning fluid conduit

58″ cut off valve

60 piston

60′ face of piston 60

61 scraping device

62 piston rod

66 bypass device

66′ bypass device

67 bore hole

67′ bore hole

68 valve flap

68′ valve Sap

70 storage tank

71 outlet of storage tank 70

71′ cutoff valve

72 feed conduit

73 feed pump

74 inert gas conduit

74′ inert gas cutoff valve

75 outlet conduit

75′ cutoff valve

76 cleaning outlet

76′ cutoff valve

101 device

110 housing

110′ inlet portion

110″ cylindrical center portion

110′″ outlet portion

111 suspension inlet

112 sieve element

115 filtrate outlet

116 non-filtrate outlet

117 filtrate space

119 solid material output opening

203 compressor device

210 housing

210′ inlet portion

210′″ outlet portion

212 sieve element

212′ circumferential wall

212″ sieve opening

213 filter surface

216 non-filtrate space

216′feed portion

216″ compression portion

219 solid material output opening

220 closure element

F filtrate

F′ filtrate space

G compressed gas

H double arrow

I inert gas

P solid material particles

R cleaning

U suspension

W washing liquid

WF mix of washing liquid and brew liquid

X cylinder axis

What is claimed is:

1. A device for a precipitating solid material particles from a suspension of a brew liquid including dissolved CO₂ and plant based aroma bearer solid material particles, the device comprising:
a filter surface which separates a non-filtrate space from a filtrate space wherein the non-filtrate space receives the suspension;
a suspension inlet leading into the non-filtrate space,
a filtrate outlet opening into the filtrate space;
a mechanical compressor device that is provided in the non-filtrate space and configured to feed the suspension under a separation of the brew liquid through the filter surface within the non-filtrate space along the filter surface to a compression portion of the non-filtrate space and to compress the remaining solid materials;
and a solid material output opening provided in a wail of the non-filtrate space in the compression portion of the non-filtrate space wherein the solid material output opening is closeable gas tight and pressure tight relative to an ambient atmosphere.

2. The device according to claim 1, wherein the mechanical compressor device is formed by a compressor screw which is arranged rotatable in a sieve tube including the filter surface.

3. The device according to claim 2,
wherein the compressor screw includes a feed section and a compressor section, and
wherein the feed section transitions into the compressor section continuously.

4. The device according to clam 2, wherein a helical radially outer edge of the compressor screw is arranged directly adjacent to the filter surface.

5. The device according to claim 4,
wherein the compressor screw is provided with at least one scraping device at the helical radially outer edge of the compressor screw, and
wherein the scraping device contacts the filter surface.

6. The device according to claim 1,
wherein the mechanical compressor device includes a piston that is axially movable between a decompression position and a compression position in a cylinder including the filter surface and radially defining the non-filtrate space,
wherein bypass devices are provided which facilitate a flow of suspension into the compression portion of the non-filtrate space when the cylinder is moved into the decompression position.

7. The device according to claim 6, wherein the bypass devices are formed by openings in the piston that are provided with check valves.

8. The device according to claim 1,
wherein the solid material output opening is provided with a closure element which is preloaded by a preload force into a closed position where the solid material output opening is closed by the closure element gas tight and pressure tight.

9. The device according to claim 8, wherein the closure element is preloaded by a spring into the closed position against a sealing seat of the solid material output opening.

10. The device according to claim 1, wherein the solid material output opening is connected with a solid material output conduit which leads into a pressurized solid material collecting container.

11. The device according to claim 10, wherein the solid material collecting container includes a pressurized gas feed through which pressurized gas is introducible into an interior of the solid material collecting container.

12. The device according to claim 1, wherein at least one fluid inlet opening for a washing fluid for solid material cake washing is provided in front or in the compression portion of the non-filtrate space.

13. A method for precipitating solid material particles from a suspension including a brew liquid including dissolved CO₂ and plant based aroma bearer solid material particles using a device according to one of the preceding claims and comprising the steps:
continuously feeding the suspension from a brew liquid including solid material particles into the non-filtrate space;
feeding the suspension in the non-filtrate space along the filter surface while precipitating the brew liquid through the filter surface and compressing the solid materials into a compressed solid materials cake; and
continuously outputting the said material cake from the non-filtrate space through the solid material output opening while maintaining a positive pressure in the non-filtrate space relative to the ambient atmosphere.

14. The method according to claim 13,
wherein the solid material output opening from a start-up of the device until a compressed filter cake is built up is
either closed by a closure element, or
is in fluid connection with an external pressure cavity in which a pressure is provided which corresponds to a positive pressure in the non-filtrate space.

15. The method according to claim 13, wherein a washing liquid, for example water is added to the solid material cake shortly before reaching a maximum compression of the solid material cake.
